(19) United States
(12) Patent Application Publication
(10) Pub. No.: US 2018/0297222 A1
(43) Pub. Date: Oct. 18, 2018

(54) SHAVING RAZOR SYSTEM

(71) Applicant: The Gillette Company LLC, Boston, MA (US)

(72) Inventor: Matthew James Hodgson, Ramsbury (GB)

(21) Appl. No.: 15/951,312

(22) Filed: Apr. 12, 2018

Related U.S. Application Data
(60) Provisional application No. 62/486,628, filed on Apr. 18, 2017.

(51) Int. Cl. B26B 21/44; B26B 21/52

(52) U.S. Cl. CPC B26B 21/446; B26B 21/521; B26B 21/522

(57) ABSTRACT

A personal care product with a tottle having a first end with a port for dispensing a liquid and an opposing second end. A coupler is mounted to the second end of the tottle. The coupler has an upper portion, a lower portion and a flexible hinge between the upper portion and the lower portion. The upper portion is spaced apart from the lower portion in an open position and the upper portion is sealed against the lower portion in a closed position.

### FIELD OF THE INVENTION

The present invention relates to personal care articles and more particularly to shaving razor systems that have a coupler mounted to a tottle.

### BACKGROUND OF THE INVENTION

In general, a cartridge or blade unit of a safety razor has at least one blade with a cutting edge which is moved across the surface of the skin being shaved by means of a handle to which the cartridge is attached. Some shaving razors are provided with a spring biased cartridge that pivots relative to the handle to follow the contours of the skin during shaving. The cartridge may be mounted detachably on the handle to enable the cartridge to be replaced by a fresh cartridge when the blade sharpness has diminished to an unsatisfactory level, or it may be attached permanently to the handle with the intention that the entire razor be discarded when the blade or blades have become dulled.

Razor blade assemblies have been disclosed wherein cutting-edge portions of the blade members are held between skin engaging surfaces which are generally referred to as the guard and cap of the razor blade assembly. The guard contacts the skin in front of the blade member(s) and the cap contacts the skin behind the blade member(s) during a shaving stroke. The cap and guard may aid in establishing the so-called “shaving geometry”, i.e., the parameters which determine the blade orientation and position relative to the skin during shaving, which in turn have a strong influence on the shaving performance and efficacy of the razor. The cap may comprise a water leachable shaving aid to reduce drag and improve comfort. The guard may be generally rigid, for example formed integrally with a frame or platform structure which provides a support for the blades. Guards may also comprise softer elastomeric materials to improve skin stretching.

Personal care givers often care for individuals who are unable to shave themselves because of decreased mental and/or physical capacity often brought about by chronic age, injury, or various degenerative diseases. The task of shaving another person requires extreme care, patience, coordination and spatial awareness to avoid cutting the person being shaved. In the United States, barbers are licensed and often have years of experience shaving other people. However, close family members and professional care givers are much less familiar with shaving techniques for shaving another person. Furthermore, barbers typically use a straight edge razor, which would be very dangerous for a personal care giver or family member to attempt using on another person without proper training. Wet safety razor shaving systems have been enhanced for over one hundred years for self-application. However, these designs are suboptimal for shaving another person. In addition, the shaving razor cartridge must be kept clean in between shaving strokes. Current shaving razor systems are designed to lie down (i.e., horizontally) on a flat surface, thus the cartridge may potential contact an unsanitary surface, which may result in an infection which could be potentially deadly to older or disabled people with compromised immune systems.

Tottles are typically used for dispensing various types of fluid compositions for personal care products. However, there are no simple and intuitive methods for attaching a personal care article to a tottle. Thus, there is a need for an easy method and apparatus for attaching a personal care article to a tottle in a simple, efficient and secure manner by either the original manufacturer or the consumer.

Thus, there is a need for a shaving razor cartridge mounted to an ergonomic handle to allow for proper control, grip and manipulation for shaving another person's face, as well as easily stand up in a vertical position.

### SUMMARY OF THE INVENTION

In one aspect, the invention features, in general a personal care product with a tottle having a first end with a port for dispensing a liquid and an opposing second end. A coupler is mounted to the second end of the tottle. The coupler has an upper portion, a lower portion and a flexible hinge between the upper portion and the lower portion. The upper portion is spaced apart from the lower portion in an open position and the upper portion is sealed against the lower portion in a closed position.

In another aspect, the invention features, in general a method of assembling a personal care product. A tottle is provided having a seal at a first end and a port at an opposing end. A coupler is provided having a flexible hinge between an upper portion and a lower portion of the coupler. The coupler is mounted to the tottle. The upper portion is moved from an open position with the upper portion and lower portion spaced apart to a closed position with the upper portion engaged with the lower portion engaged. The upper portion is secured to the lower portion.

In another aspect, the invention features, in general a coupler for attaching a shaving razor cartridge to a bottle. The coupler has an alignment hole, an alignment pin and a flexible hinge between the alignment hole and the alignment pin. The alignment pin is spaced apart from the alignment hole in an open position and the alignment pin is positioned within the alignment hole in a closed position.

### BRIEF DESCRIPTION OF THE DRAWINGS

Other features and advantages of the present invention, as well as the invention itself, can be more fully understood from the following description of the various embodiments, when read together with the accompanying drawings, in which:

FIG. 1 is a perspective view of a shaving razor system according to one possible embodiment of the present invention.

FIG. 2A is a side view of the shaving razor system of FIG. 1 in a standing position.

FIG. 2B is a side view of the shaving razor system of FIG. 1 in a tipped position.

FIG. 3A is a side view of another possible embodiment of a shaving razor system in a standing position.

FIG. 3B is a side view of the shaving razor system of FIG. 3A in a tipped position.

FIG. 4A is a rear view of the shaving razor system of FIG. 1.

FIG. 4B is a cross sectional view of the shaving razor system of FIG. 1 taken generally along the line 4-4 of FIG. 1.

FIG. 5 is an assembly view of a tottle and a coupler of the shaving razor system of FIG. 1.

FIG. 6 is a perspective view of the tottle and the coupler in a first position.

FIG. 7 is a perspective view of the tottle and the coupler in a second position.

### DETAILED DESCRIPTION OF THE INVENTION

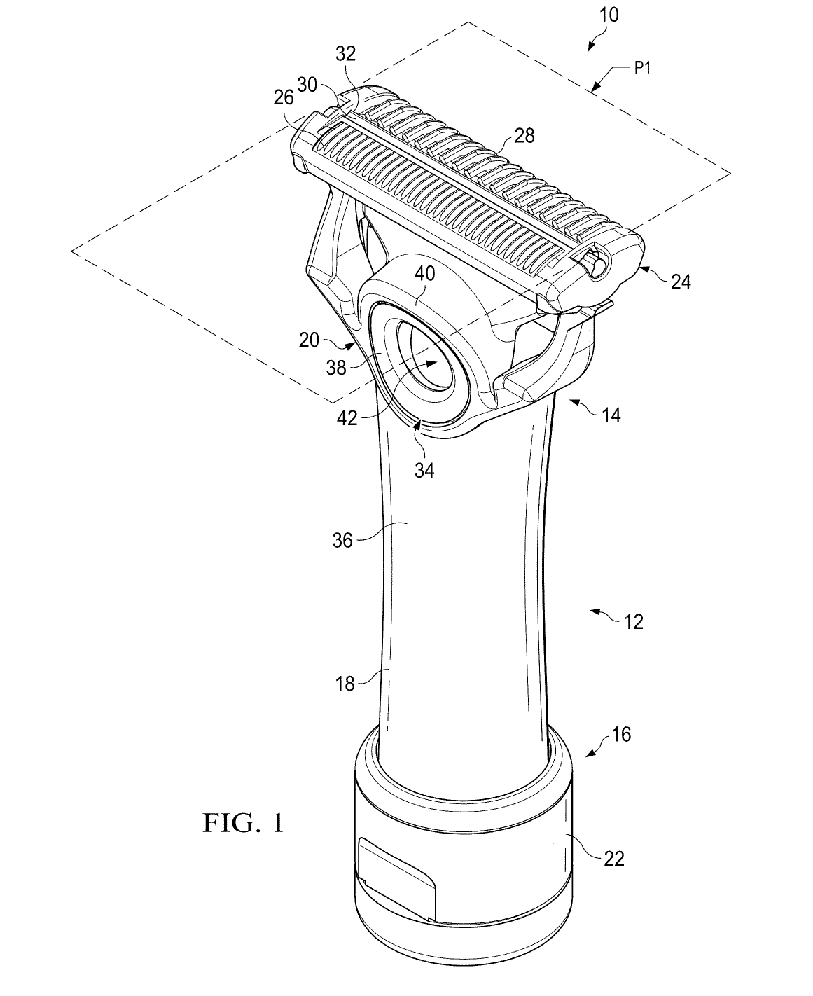

Referring to FIG. 1, a perspective view is shown of a shaving razor system 10. The shaving razor system 10 may include a handle 12 having a first end 14 and a second end 16. In certain embodiments, the handle 12 may include a flexible tottle 18 for containing a liquid, such as a pre-or post-shaving aid composition. A tottle is an industry word for a type of bottle (often used for ketchup, shampoo, etc.) that sits on a cap at the end. For example, a “bottle” sits on its “bottom” and dispenses a liquid from the opposite end (top) which has a cap, a “tottle” sits on its “top,” which is the end that dispenses a liquid and has the end cap. The handle 12 may also include a coupler 20 mounted to the first end 14 of the handle 12 and an end cap 22 (e.g., removable cover or flip top) at the second end 16 of the handle 12 to prevent fluid from exiting the handle 12. A shaving razor cartridge 24 may be mounted to the coupler 20. The shaving razor cartridge 24 may include a cap 26, a guard 28 and a blade 30 having a cutting edge 32 positioned between the cap 26 and the guard 28. The cap 26 and the guard 28 may establish a shaving plane P1 (i.e., plane tangent to the cap 26 and the guard 28).

The coupler 20 may include a finger pad 34 on a top surface 36 of the handle 12 (e.g., the tottle 18) for receiving and properly positioning a user's finger or thumb. The finger pad 34 may be circular and have a large radius to receive the thumb of a user or better maintain a user's finger on the finger pad 34. For example, the finger pad 34 may have a radius of about 5 mm to about 15 mm. The finger pad 34 may also have a concave top surface 38 and a forward rim 40. The shaving razor cartridge 24 may be positioned in front of the forward rim 40 of the finger pad 34 (e.g., to facilitate aiming the shaving razor cartridge 24 in the direction of another person's face during shaving). The concave surface 38 may arc in an upward direction and have a radius of about 7 mm to about 25 mm. In certain embodiments, the finger pad 34 may define an opening 42 extending completely through the finger pad 34 to the top surface 36 of the handle 12 (e.g., tottle 18) thus allowing the user's finger or thumb to rest deeper within the finger pad 34. The top surface 36 of the tottle 18 at a bottom of the opening 42 may also provide a cushion for improved comfort. Although the coupler 20 is illustrated as attaching the shaving razor cartridge 24 to the tottle 18, the coupler 20 may be used to attach other personal care articles to the tottle 18 or other fluid liquid dispensers.

During the act of shaving another person's face, a shaving razor must be put down numerous times as the care giver re-positions the person being shaved. When a person is shaving themselves, they rarely put down the shaving razor between strokes. Typically, the user only puts the razor down when they are finished shaving themselves. Conventional shaving razor systems are designed to rest horizontally on a flat surface. However, this may result in contamination of the razor. Used razor cartridges may carry blood borne pathogens and present a cross infection risk for the care giver or other individuals within close proximity. This is especially dangerous for individuals with suppressed immunity. Furthermore, care givers typically shave people in their rooms, not necessarily at a bathroom sink or counter top. Accordingly, the shaving razor system may need to rest on a surface that is not easily cleaned off.

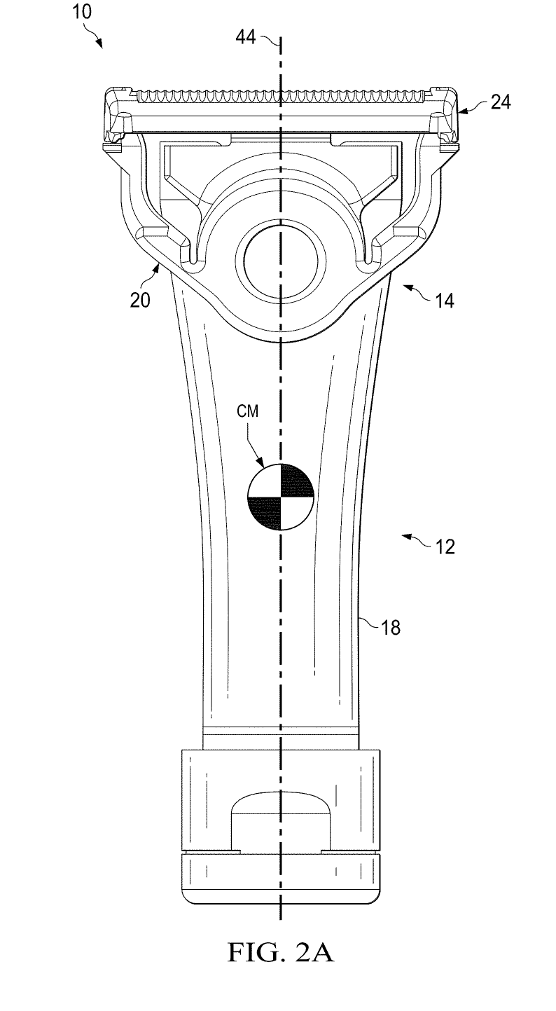

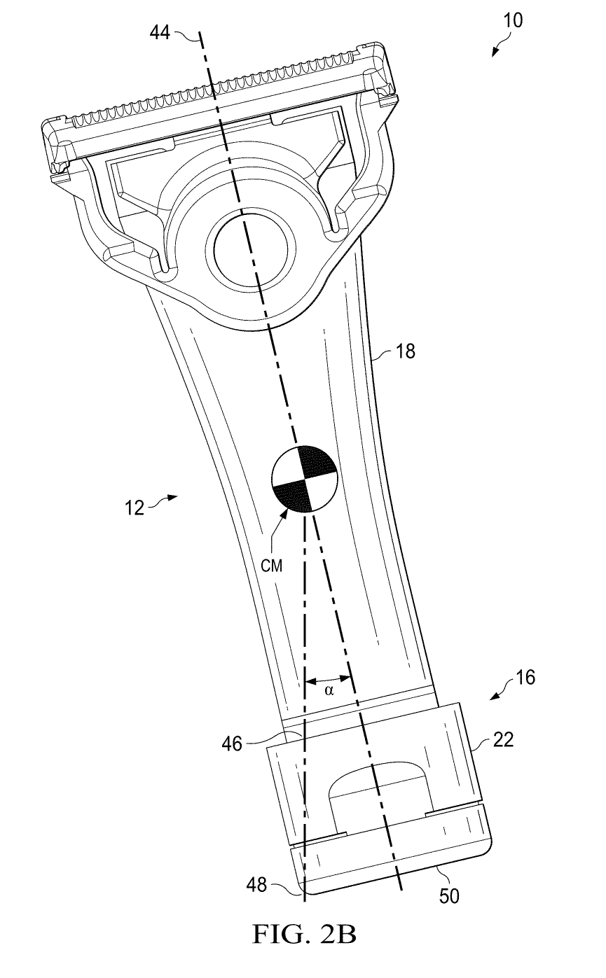

Referring to FIG. 2A the shaving razor system 10 of FIG. 1 is shown in an upright, vertical position. When the tottle 18 of the shaving razor system 10 is full, the shaving razor system 10 may have a center of mass “CM”. The center of mass “CM” may lie along a center longitudinal axis 44 of the shaving razor system 10 (i.e., approximate center line extending along a length of the shaving razor system 10). The center of mass “CM” may be calculated in a full or empty condition for the tottle 18. For example, the center longitudinal axis 44 may be calculated by extending a line from the center of mass to a center of the bottom surface 50. It is understood that as liquid is removed from the tottle 18, the center of mass “CM” may shift, making the shaving razor system 10 easier to tip over. Furthermore, the added weight at the first end 14 of the handle 12 (e.g., the coupler 20 and the cartridge 24) may also make the shaving razor system 10 easier to tip over. Tottles generally do not have components added to an end opposite the fluid opening and thus do not experience tipping issues.

Referring to FIG. 2B the shaving razor system 10 is shown in a tipped position. The second end 16 of the handle 12 may rest on a flat surface, such as a countertop or desk. As will be described in greater detail below, the shaving razor system 10 may be designed to allow for a tip angle “α” of about 10 degrees to about 15 degrees to prevent the shaving razor cartridge 24 from contacting the surface that the handle 12 may rest on. In certain embodiments, the tipping angle “α” may be determined as the angle between the center longitudinal axis 44 passing through the center of mass “CM” and a line 46 extending from an outer edge 48 of a bottom surface 50 of the handle 12 (e.g., the end cap 22) through the center of mass “CM”. The tipping angle “α” may be calculated as an average of the tottle 18 in a full or empty condition. In certain embodiments, the shaving razor system 10 may have a mass of about 10 grams to about 40 grams in a full or empty condition.

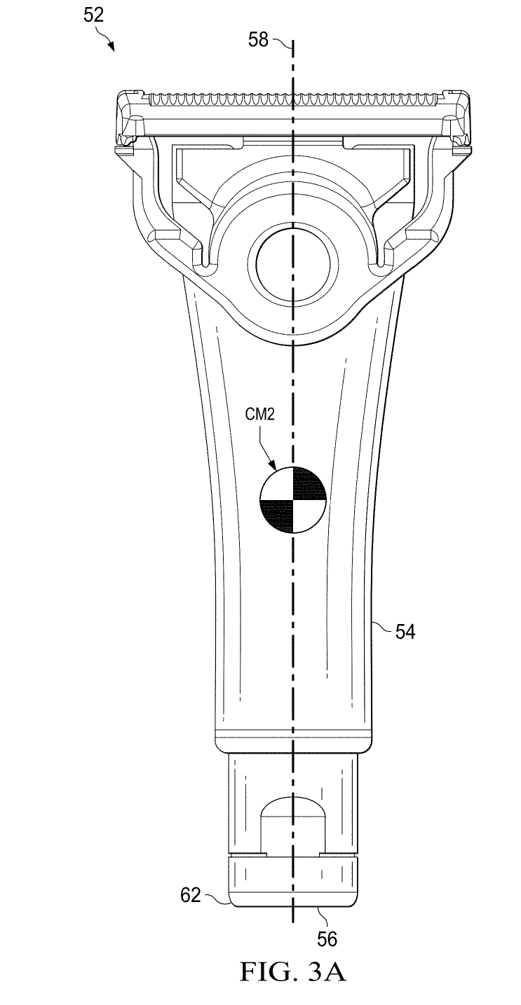

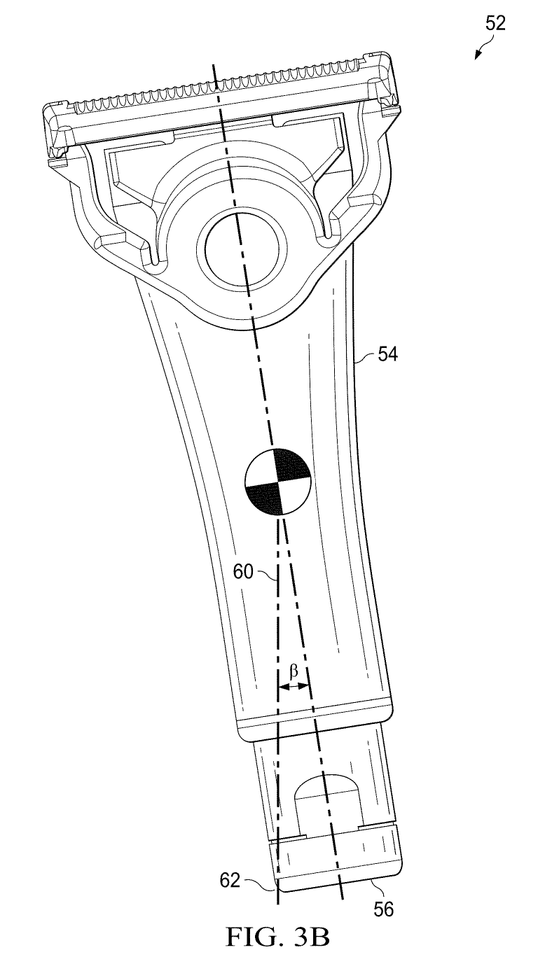

The bottom surface 50 of the handle 12 may facilitate the shaving razor system 10 to be maintained in a standing upright position. The bottom surface 50 may be enlarged to allow the shaving razor system 10 to resist tipping (e.g., enable a larger tip angle). Razor systems are typically not designed to stand in an upright position without utilizing an external support, such as a stand. Furthermore, tottles typically have a bottom surface that is less than a cross sectional area of the tottle body. For example, FIGS. 3A and 3B illustrate a shaving razor system 52 having a tottle 54 with a smaller bottom surface 56. Accordingly, a tipping angle “β” of the shaving razor system 52 shown in FIGS. 3A and 3B is much less than the tipping angle “α” of the shaving razor system 10 shown in FIGS. 2A and 2B. As shown in FIG. 3B, the tipping angle “β” of the shaving razor system 52 may be about 7 degrees, as measured from the center longitudinal axis 58 passing through a center of mass “CM2” of the tottle 54 and a line 60 extending from an outer edge 62 of the bottom surface 56 through the center of mass “CM2”. A single use shaving razor system (such as the shaving razor system 10) with tottles are more likely to tip over because of the relatively small size of the tottle (e.g., contains less fluid and thus less mass) and the larger relative weight of the razor cartridge and attachment components. Furthermore, smaller tottle typically have a smaller bottom surface.

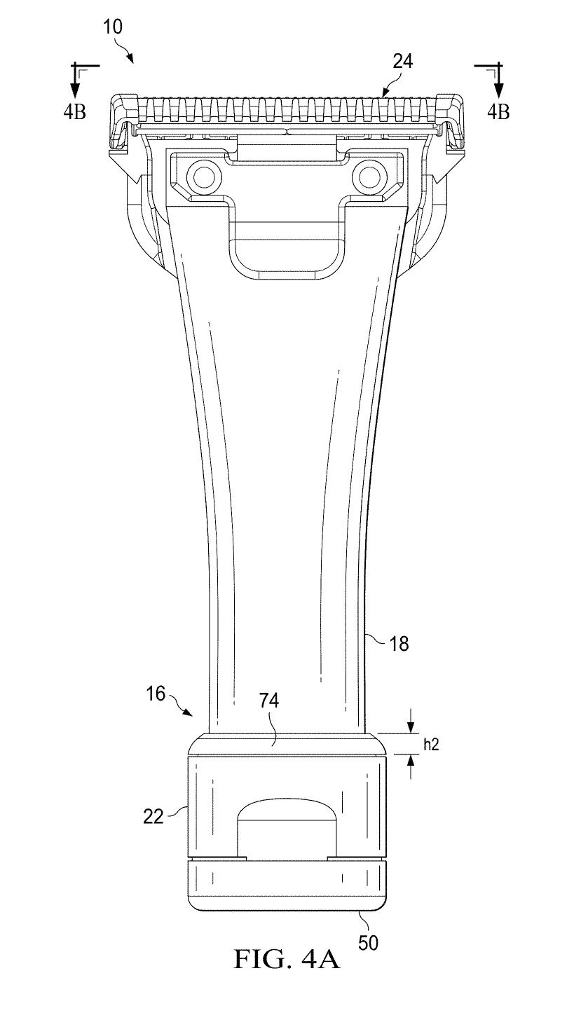

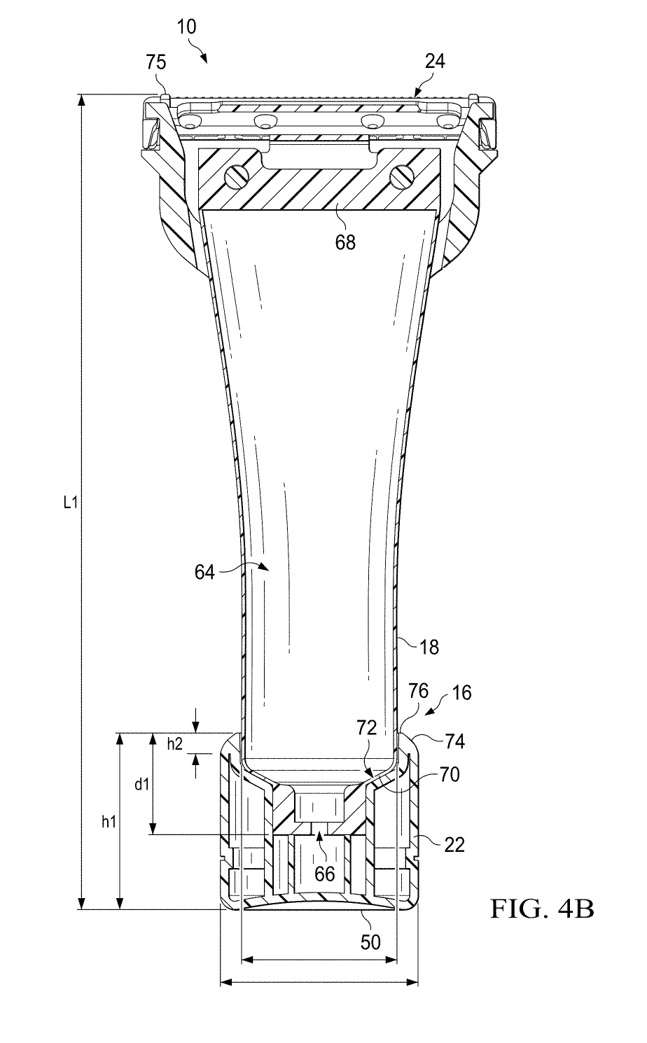

Referring to FIGS. 4A and 4B, a rear view and a cross sectional view of the shaving razor system 10 are shown, respectively. The end cap 22 may be mounted to the second end 16 of the tottle 18 by press fitting, threaded connections, ultra-sonic welding or other commonly known assembly methods. The tottle 18 may define a cavity 64 containing a liquid, such as a pre-or post- shave composition. The tottle 18 may have a fluid port 66 at one end and a seal 68 at an opposite end. The tottle 18 may have a maximum cross-sectional area between the seal 68 and the fluid port 66. The maximum cross-sectional area of the tottle 18 is typically toward the fluid port 66 because the cross-sectional area near the seal 68 typically flattens out and becomes smaller to allow the tottle 18 to be sealed. The bottom surface 50 (e.g., of the end cap 22) may have a contact area greater than the maximum cross-sectional area of the tottle 18 to provide improved stability (resist tipping). The contact area may be the projected footprint of the bottom surface 50. Accordingly, recesses, concavities, and openings may not decrease the contact area of the bottom surface even though a portion of the bottom surface is not in physical contact with a resting surface.

In certain embodiments, a ratio of the contact area of the bottom surface 50 to the maximum cross-sectional area of the tottle 18 may be greater than 1.0. For example, the ratio of the maximum cross sectional of the tottle 18 to the contact area of the bottom surface may be about 1.1 to about 9.0 and more preferably about 1.1 to about 2.0. It is understood that the contact area may represent the overall footprint of the bottom surface 50. Accordingly, openings or recesses in the bottom surface 50 may not change the contact area. In certain embodiments, the contact area of the bottom surface 50 may be about 0.28 cm² to about 14 cm².

The tottle 18 may have a rim 70 that tapers to a smaller cross-sectional area of the fluid port 66. The end cap 22 may be positioned over the rim 70 to capture a greater length of the tottle 18 and provide improved stability. For example, the end cap 22 may define a recess 72 dimensioned to receive rim 70 of the tottle 18. The recess may have a depth “d1” that is at least 20% of a height “h1” of the end cap 22. For example, the depth “d1” may be about 50% to 75% of the height “h1” of the end cap 22. The end cap 22 may have a shoulder 74 that tapers to a top edge 76. The shoulder 74 may provide a gripping area for a user to position their fingers when holding the shaving razor system 10. In certain embodiments, the shoulder 74 may have a height h2 extending around the tottle 18 (or end cap 22) of at least 1 mm and more preferably, at least 3 mm. The shaving razor system 10 may have an overall length “L1” extending from and an end 25 of the cartridge 24 to the bottom surface 50. The end cap 22 may be positioned over a length of the tottle that is at least 10% of the overall length “L1” of the tottle 18. For example, the end cap 22 may be positioned over a length of the tottle that is about 10% to about 25% of the overall length “L1” of the shaving razor system 10 to further prevent tipping.

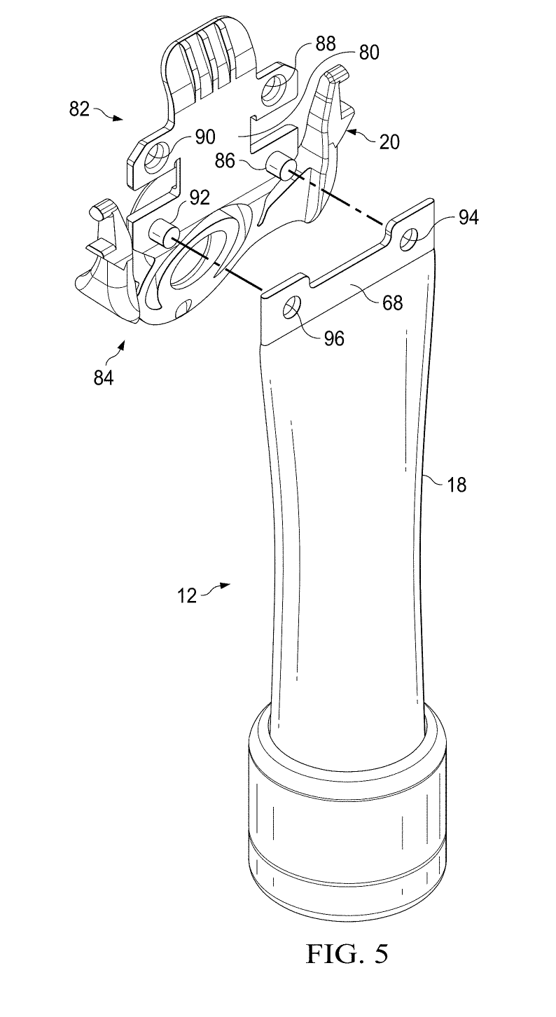

Referring to FIG. 5, a perspective assembly view is shown of the handle 12. The coupler 20 may be mounted to the seal 68 of the tottle 18. The coupler 20 may have a flexible hinge 80 between an upper portion 82 and a lower portion 84. The coupler 20 may have a first alignment pin 86 and a corresponding alignment hole 88. The first alignment pin 86 may be positioned on the lower portion 84 and the alignment hole 88 may be positioned on the upper portion 82. It is understood that the coupler 20 may have a plurality of alignment holes and corresponding alignment pins. For example, the upper portion 82 may include a second alignment hole 90 and the lower portion 84 may have a corresponding alignment pin 92. A plurality of alignment pins 86 and 92 may provide more improved positioning of the coupler 20 to the tottle 18 during assembly, as well as, improved securement of the coupler 20 to the tottle 18. For example, the pair of alignment pins 86 and 92 may better resist rotation of the coupler 20 during assembly and/or during use.

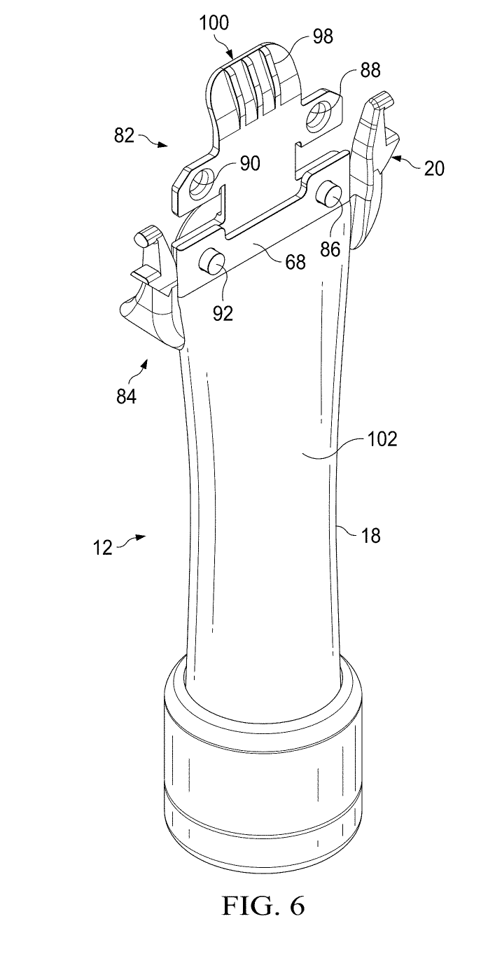

Now referring to FIGS. 5 and 6, perspective assembly views of the handle 12 are shown. FIG. 5 illustrated the coupler 20 prior to being mounted to the tottle 18. FIG. 6 illustrates the coupler 20 mounted to the tottle 18. The seal 68 may define one or more openings 94 and 96 configured to receive the corresponding alignment pins 86 and 92 in a first position (e.g., an open position). The coupler 20 may be mounted to the top surface 36 (see FIG. 1) and the alignment pins 86 and 92 may be positioned within the openings 94 and 96 of the seal 68. In the first position, the upper portion 82 may be spaced apart from the lower portion 84. Accordingly, the alignment holes 88 and 90 are spaced apart and not engaged with the alignment pins 86 and 92, in the first position.

The coupler 20 may have a second position (e.g., close position) with the upper portion 82 engaged with the lower portion 84. The upper portion 82 may be pivoted or flexed to engage with the lower portion 84. For example, the alignment pins 86 and 92 may be positioned within the corresponding alignment holes 88 and 90 and also within the openings 94 and 96 of the seal 68 (FIG.

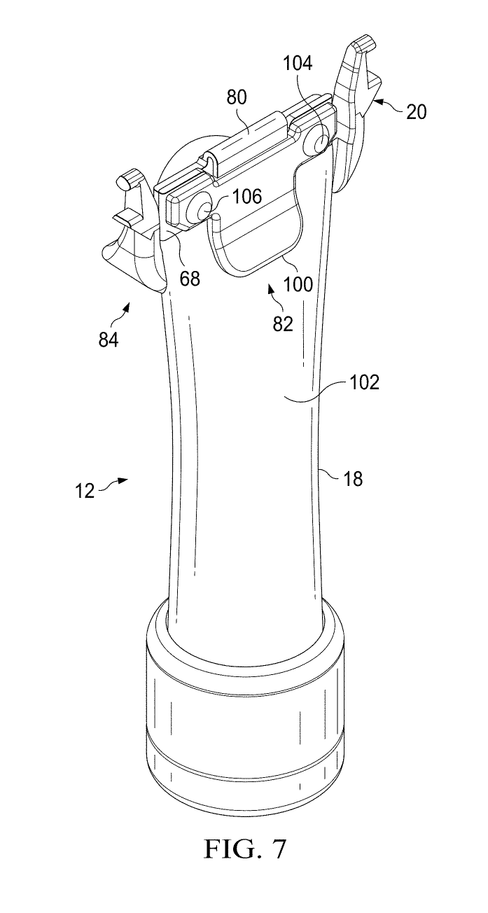

7). The upper portion 82 may have a plurality of ribs 98 on a rigid tab 100, which may help provide an improved seal against the tottle 18. For example, the upper portion may be compressed against the tottle 18 (in the second position) causing the ribs 98 to clamp against the tottle 18 and material on a bottom surface 102 of the tottle 18 to be compressed between the ribs 98. The upper portion 82 may be sealed against the lower portion 84, as shown in FIG. 7. The flexible hinge 80 may flex to allow movement between the first and second positions. FIG. 7 illustrates the flexible hinge 80 in the flexed position. In the second position, one or more of the alignment pins 86 and 92 (shown in FIG. 6) may be cold staked, forming rivets 104 and 106 on the alignment pins 86 and 92, thus securing the upper portion 82 to the lower portion 84 and securing the coupler 20 to the tottle 18. Other permanent or temporary securing methods may also be used, such as, adhesives, ultra-sonic welding, snap fitting, press fitting and hot staking. It is understood that the shaving razor system may be provided as a kit that can be assembled by a consumer or is a complete unit. In other embodiments, the coupler 20 and the razor cartridge 24 (FIG. 1) may be sold together as a kit that can be attached to a tottle of the consumer's choice.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm ” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A personal care product comprising:
a tottle having a first end with a port for dispensing a liquid and an opposing second end;
a coupler mounted to the second end of the tottle, the coupler having an upper portion, a lower portion and a flexible hinge between the upper portion and the lower portion, wherein the upper portion is spaced apart from the lower portion in a first position and the upper portion is sealed against the lower portion in a closed position.

2. The personal care product of claim 1 wherein the lower portion includes a finger pad having a forward rim.

3. The personal care product of claim 1 wherein the coupler has a first alignment pin and an alignment hole.

4. The personal care product of claim 3 wherein the seal has an opening configured to receive the alignment pin in the open position.

5. The personal care product of claim 4 wherein the alignment pin is positioned within an opening of the seal and the opening of the coupler in the closed position.

6. The personal care product of claim 1 wherein the coupler has a pair of openings dimensioned to receive a pair of respective alignment pins on the coupler.

7. The personal care product of claim 6 wherein the pair of alignment pins are positioned within a pair of respective openings in the coupler and the pair of respective openings of the seal.

8. The personal care product of claim 1 further comprising a shaving razor cartridge mounted to a pair of arms extending from the coupler.

9. The personal care product of claim 1 wherein the coupler comprises a rigid tab having a plurality of spaced apart ribs contacting a bottom surface of the tottle.

10. The personal care product of claim 1 wherein the lower portion includes a finger pad that defines an opening.

11. A method of assembly for a personal care product comprising:
providing a tottle having a seal at a first end and a port at an opposing end;
providing a coupler having a flexible hinge between an upper portion and a lower portion;
mounting the tottle to the coupler;
moving the upper portion from an open position with the upper portion and lower portion are spaced apart to a closed position with the upper portion and lower portion engaged; and
securing the upper portion to the lower portion.

12. The method of claim 11 further comprising mounting a shaving razor cartridge to the coupler.

13. The method of claim 11 further comprising engaging an alignment pin on the coupler with a corresponding alignment hole on the coupler before securing the upper portion to the lower portion.

14. The method of claim 12 further comprising positioning the alignment pin within a hole in the seal.

15. The method of claim 11 further comprising engaging a pair of alignment pins on the coupler with a corresponding pair of alignment holes on the coupler and positioning the pair of alignment pins within a pair of corresponding thru holes in the seal before securing the upper portion to the lower portion.

16. A coupler for attaching a shaving razor cartridge to a bottle comprising:
an alignment hole;
an alignment pin; and
a flexible hinge between the alignment hole and the alignment pin, wherein the alignment pin is spaced apart from the alignment hole in an open position and the alignment pin is positioned within the alignment hole in a closed position.

17. The coupler of claim 16 further comprising a pair of arms configured to attached to a shaving razor cartridge.

18. The coupler of claim 16 further comprising a rigid tab having a plurality of spaced apart ribs.

19. The coupler of claim 16 further comprising a finger pad that defines an opening.

20. The coupler of claim 19 wherein the opening extends completely thru the finger pad.
